(19) United States
(12) Patent Application Publication
(10) Pub. No.: US 2021/0080071 A1
(43) Pub. Date: Mar. 18, 2021

(54) SOLAR ILLUMINATON DISTRIBUTION SYSTEM

(71) Applicant: MA'AN NASSAR RAJA AL-ANI, TAMPA, FL (US)

(72) Inventor: MA'AN NASSAR RAJA AL-ANI, TAMPA, FL (US)

(21) Appl. No.: 16/611,810

(22) PCT Filed: Jun. 14, 2017
(86) PCT No.: PCT/US2017/037520

§ 371 Date: Nov. 7, 2019

(51) Int. Cl. F21S 11/00; F21V 8/00; F21V 7/06; F21V 9/06

(52) U.S. Cl. CPC F21S 11/007; G02B 6/0008; F21V 9/06; F21V 7/06; F21S 11/005

(57) ABSTRACT

The solar illumination distribution system (10) uses a series of parabolic reflectors (12, 14, 42, 44, 46) and other optical components to direct and distribute solar radiation onto a desired surface (G), such as for illuminating a stadium or arena as well as providing light for the growth of natural turf in desired locations within the stadium or arena. A primary parabolic reflector (12) and a secondary parabolic reflector (14) focus solar radiation onto one end of a fiber optic bundle (24), which transmits the solar radiation to a desired location. At the desired location, the light transmitted through the fiber optic bundle (24) is distributed through a plurality of fiber optic cables (36, 38, 40) to a plurality of tertiary parabolic reflectors (42, 44, 46) to illuminate the desired surface (G).

### TECHNICAL FIELD

The present invention relates to illumination systems, and particularly to a solar illumination distribution system for transmitting solar radiation from a solar collector to a remotely positioned light distributor.

### BACKGROUND ART

Open air stadia, arenas and the like present unique difficulties with regard to illumination. Due to movement of the sun throughout the day, at least some portion of an open air stadium or arena will be in shadow. Although these areas can be selectively illuminated with electric lighting, this practice is both costly and not environmentally friendly, particularly when sunlight is readily available at no cost. In addition to providing conventional illumination, stadiums for sports, such as football, soccer and the like, often use natural turf; i.e., live plant growth in the form of grass. In order to maintain the natural turf, sufficient sunlight must be applied for photosynthesis to occur. Once again, although artificial illumination can be used to promote growth of the grass when the grass is in shadow, this practice is both costly and not environmentally friendly. Thus, a solar illumination distribution system solving the aforementioned problems is desired.

### DISCLOSURE OF INVENTION

The solar illumination distribution system uses a series of parabolic reflectors and other optical components to direct and distribute solar radiation onto a desired surface, such as for illuminating a stadium or arena as well as providing light for the growth of natural turf in desired locations within the stadium or arena. The solar illumination distribution system includes a primary parabolic reflector, having a central aperture formed therethrough, and a secondary parabolic reflector aligned with or adjacent to a focal point of the primary parabolic reflector. Solar radiation is reflected from the primary parabolic reflector to the secondary parabolic reflector, and the secondary parabolic reflector reflects the solar radiation towards the central aperture formed through the primary parabolic reflector.

An upper open end of a hollow pipe is received by the central aperture formed through the primary parabolic reflector for receiving the reflected solar radiation. The lower end of the hollow pipe is closed and has an opening formed therethrough. A first end of a fiber optic bundle is received by the opening formed through the lower closed end of the hollow pipe for receiving and transmitting the reflected solar radiation. A first focusing lens is mounted in the hollow pipe for focusing the solar radiation reflected by the secondary parabolic reflector on the first end of the fiber optic bundle.

A light distribution housing is positioned away from the primary parabolic reflector, in proximity to a desired location for receiving the solar radiation. The light distribution housing has an upper opening and a plurality of lower openings formed therethrough. The second end of the fiber optic bundle is received through the upper opening for transmitting the solar radiation into the light distribution housing. A plurality of optical fiber cables are further provided, each having opposed upper and lower ends. The upper ends of the optical fiber cables are respectively received by the plurality of lower openings formed through the light distribution housing. A plano-convex lens is positioned adjacent the upper opening of the light distribution housing for diverging the solar radiation transmitted through the fiber optic bundle.

A plurality of second focusing lenses are mounted within the light distribution housing for focusing the solar radiation diverged by the plano-convex lens to respective ones of the upper ends of the plurality of optical fiber cables. A plurality of tertiary parabolic reflectors are positioned adjacent respective ones of the lower ends of the plurality of optical fiber cables for reflecting the solar radiation onto a desired surface, such as for illuminating desired portions of the stadium or arena, for example, or for providing light for growth of natural turf within the stadium or arena.

These and other features of the present invention will become readily apparent upon further review of the following specification and drawings.

### BRIEF DESCRIPTION OF THE DRAWINGS

FIG. 1 diagrammatically illustrates a solar illumination distribution system according to the present invention.

FIG. 2 diagrammatically illustrates a primary and a secondary parabolic reflector of the solar illumination system.

FIG. 3 is a side view of a tertiary parabolic reflector of the solar illumination system.

FIG. 4 is a partial side view in section of an optical fiber of the solar illumination system.

Similar reference characters denote corresponding features consistently throughout the attached drawings.

### BEST MODES FOR CARRYING OUT THE INVENTION

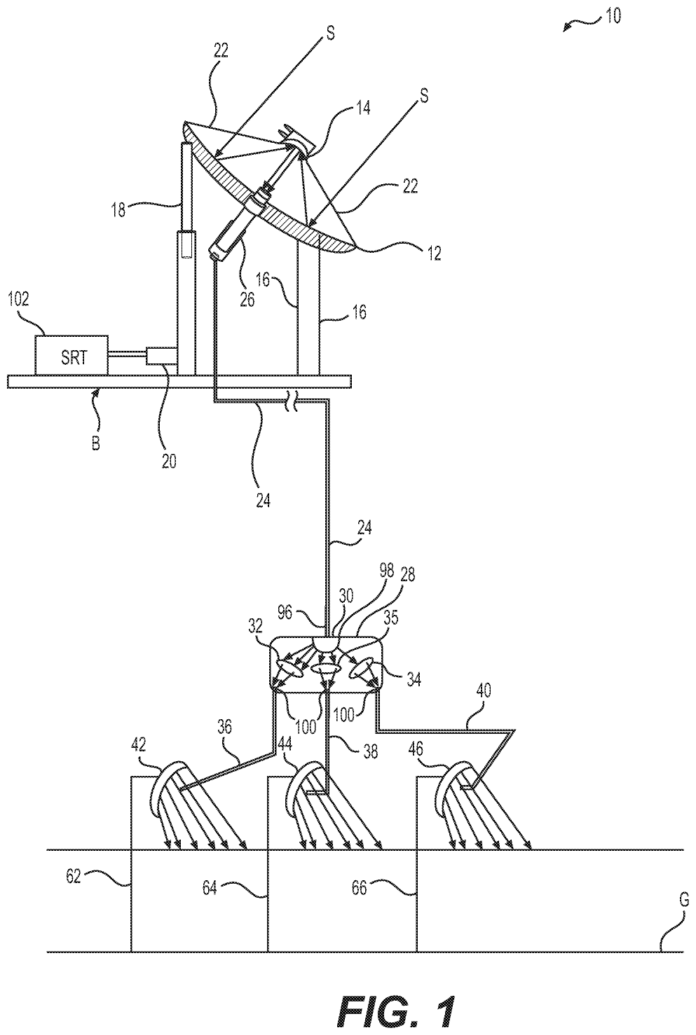

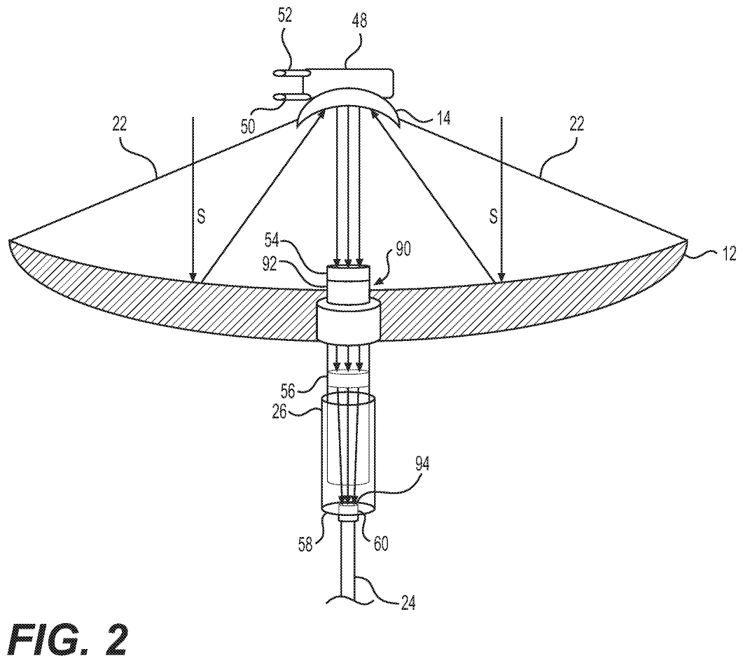

The solar illumination distribution system 10 uses a series of parabolic reflectors and other optical components to direct and distribute solar radiation onto a desired surface, such as for illuminating a stadium or arena as well as providing light for the growth of natural turf in desired locations within the stadium or arena. As best shown in FIGS. 1 and 2, the solar illumination distribution system 10 includes a primary parabolic reflector 12, having a central aperture 90 formed therethrough, and a secondary parabolic reflector 14 aligned with a focal point of the primary parabolic reflector 12. Solar radiation S is reflected from the primary parabolic reflector 12 to the secondary parabolic reflector 14, and the secondary parabolic reflector 14 reflects the solar radiation S towards the central aperture 90 formed through the primary parabolic reflector 12. As shown in FIG. 1, a plurality of support rods 22 may be used to support secondary parabolic reflector 14. It should be understood that the arrangement of support rods 22, linking the secondary parabolic reflector 14 to the circumferential edge of the primary parabolic reflector 12, shown in FIG. 1 is shown for exemplary purposes only.

It should be further understood that primary parabolic reflector 12 may be formed from any suitable material, such as, for example, 6061 aluminum alloy, which is a precipitation-hardened aluminum alloy, containing magnesium and silicon as its major alloying elements. A rear side of primary parabolic reflector 12 may be coated with a tantalum alloy or the like to provide waterproofing. Similarly, secondary parabolic reflector 14 may be formed from any suitable material, such as, for example, an aluminum-silicon alloy, providing secondary parabolic reflector 14 with resistance against extreme temperatures. For a secondary parabolic reflector 14 using 13% of alloy components (Al—Si), it is expected that a reflector made from such an aluminum-binary eutectic alloy should be able to resist temperatures up to approximately 550° C.

A solar radiation tracker (SRT) 102 may be used in combination with a motor 20 or the like for positioning of primary parabolic reflector 12 to track movement of the sun across the sky over time. As is well known in the art, the primary parabolic reflector 12 may be mounted on an adjustable arm 18, driven by motor 20, under the control of SRT 102. It should be understood that the arrangement of adjustable arm 18, motor 20, SRT 102, additional supports 16 and the primary parabolic reflector 12, all mounted on a base B, is shown for exemplary purposes only, and that any suitable type of solar tracking system may be utilized. For example, solar tracking system for use with parabolic solar concentrators are shown in U.S. Pat. Nos. 6,886,339 B2; 5,191,876; and 4,628,142, each of which is hereby incorporated by reference.

Additionally, as shown, a reservoir or tank 48 may be mounted on the secondary parabolic reflector 14 for receiving a volume of water to be heated. The reservoir or tank 48 has a water inlet 50 and a water outlet 52, allowing water to be heated to flow through the reservoir or tank 48 under control of an external pump or the like. It should be understood that reservoir or tank 48 may be formed from any suitable material, such as copper or the like. In an exemplary application, reservoir or tank 48 may be fed from a larger tank associated with the stadium or arena's water supply, and the resultant hot water can be used for any desired purpose. In addition to providing hot water, the heat exchange with the secondary parabolic reflector 14 is expected to keep the temperature of the secondary parabolic reflector 14 below 100° C. In addition to providing hot water, which may be used for thermoelectric applications or the like, primary parabolic reflector 12 may have solar cells or the like mounted circumferentially for providing additional photoelectric power.

An upper open end 92 of a hollow pipe 26 is received by the central aperture 90 formed through the primary parabolic reflector 12 for receiving the reflected solar radiation S. The lower end 58 of the hollow pipe 26 is closed and has an opening 60 formed therethrough. A first end 94 of a fiber optic bundle 24 is received by the opening 60 formed through the lower closed end 58 of the hollow pipe 26 for receiving and transmitting the reflected solar radiation S. Hollow pipe 26 may have any desired relative dimensions, dependent upon the positioning and application of system 10. An exemplary hollow pipe 26 may have a diameter of approximately 30 mm at its upper end. For an exemplary telescopic pipe, such as that shown, the lower end may have a diameter of approximately 34 mm.

A first focusing lens 56 is mounted in the hollow pipe 26 for focusing the solar radiation S reflected by the secondary parabolic reflector 14 on the first end 94 of the fiber optic bundle 24. As shown, a removable ultraviolet filter 54 is provided for selectively and removably covering the upper open end 92 of the hollow pipe 26. Thus, for purposes of illumination, ultraviolet light may be filtered out of the solar radiation S, but for purposes of plant growth, the solar radiation S with the ultraviolet component may be used. As best seen in FIG. 2, the hollow pipe 26 may be telescopically adjustable, allowing for adjustment of the length of pipe 26 dependent upon the focal length of lens 56. Corresponding to the exemplary dimensions given above, first focusing lens 56 may be, for example, a 15 cm convex lens to converge the light onto an 8 mm glass fiber optic cable (i.e., fiber optic bundle 24), carrying 33,200 individual 40 micron diameter optical fibers. For these exemplary dimensions, opening 60 may have a diameter of approximately 11 mm.

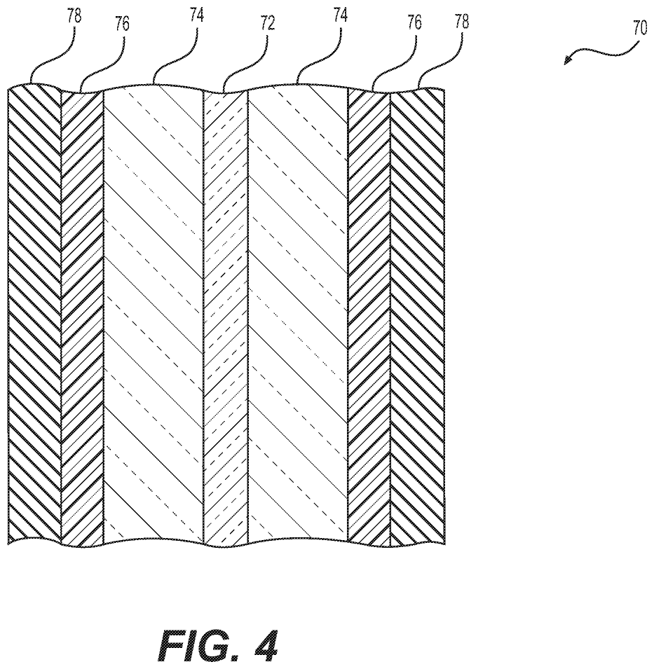

It should be understood that any suitable type of fiber optics may be utilized. Preferably, fiber optic bundle 24 is formed from a plurality of optical fibers or fiber optic cables, which may be of any suitable type, as is well known in the art. For example, as shown in FIG. 4, each individual fiber optic cable 70 forming bundle 24 may have a silica glass core 72 with a zirconium fluoride glass cladding 74 formed around it. A buffer layer 76 may then be sandwiched between the zirconium fluoride glass cladding 74 and an outer jacket 78. Preferably, cladding 74 is formed from approximately 50% to approximately 60% zirconium fluoride (ZrF₄).

A light distribution housing 28 is positioned away from the primary parabolic reflector 12, in proximity to a desired location for receiving the solar radiation S. In the example of FIG. 1, the desired location is shown as exemplary ground surface G. The light distribution housing 28 has an upper opening 98 and a plurality of lower openings 100 formed therethrough. The second end 96 of the fiber optic bundle 24 is received through the upper opening 98 for transmitting the solar radiation S into the light distribution housing 28. A plurality of optical fiber cables 36, 38, 40 are further provided, each having opposed upper and lower ends. It should be understood that only three cables 36, 38, 40 are shown in the example of FIG. 1, though any desired number of optical fiber cables may be used. As shown, the upper ends of the optical fiber cables 36, 38, 40 are respectively received by the plurality of lower openings 100 formed through the light distribution housing 28. A plano-convex lens 30 is positioned adjacent the upper opening 98 of the light distribution housing 28 for diverging the solar radiation S transmitted through the fiber optic bundle 24.

A plurality of second focusing lenses 32, 34, 35 are mounted within the light distribution housing 28 for focusing the solar radiation S diverged by the plano-convex lens 30 to respective ones of the upper ends of the plurality of optical fiber cables 36, 38, 40. A plurality of tertiary parabolic reflectors 42, 44, 46 are positioned adjacent respective ones of the lower ends of the plurality of optical fiber cables 36, 38, 40 for reflecting the solar radiation S onto the desired surface. For example, desired portions of a stadium or arena as far as 10 meters to 25 meters away can thereby be illuminated. The reflected solar radiation S can also be used for growth of natural turf within the stadium or arena. It should be understood that tertiary parabolic reflectors 42, 44, 46 may be formed from any suitable material. For example, each tertiary parabolic reflector may have a front, reflective side formed from a plated aluminum mirror coated with nanoparticles of silver and/or chromium to disperse the light, and may have a rear side coated with tantalum alloys or the like, providing protection from water.

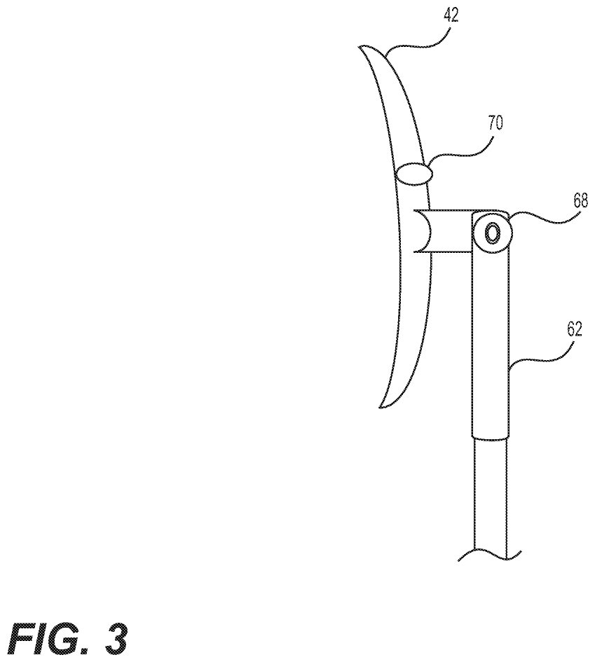

As shown in FIG. 3, tertiary parabolic reflector 42 is preferably mounted on an adjustable stand 62, allowing selective pivotal adjustment of tertiary parabolic reflector 42 with respect to ground surface G about pivot 68. It should be understood that tertiary parabolic reflectors 44 and 46 are similarly mounted on adjustable stands 64, 66, respectively. Additionally, as shown in FIG. 3, a sensor 70 may be mounted on each tertiary parabolic reflector for additional photo-activated/photo-responsive systems, such as additional lighting systems, irrigation systems or the like.

It is to be understood that the present invention is not limited to the embodiments described above, but encompasses any and all embodiments within the scope of the following claims.

1. A solar illumination distribution system, comprising:
a primary parabolic reflector having a central aperture formed therethrough;
a secondary parabolic reflector aligned with a focal point of said primary parabolic reflector, whereby solar radiation is reflected from said primary parabolic reflector to said secondary parabolic reflector, said secondary parabolic reflector reflecting the solar radiation towards the central aperture formed through said primary parabolic reflector;
a hollow pipe having an upper open end and a lower closed end, the upper open end thereof being received by the central aperture formed through said primary parabolic reflector, the lower closed end having an opening formed therethrough;
a fiber optic bundle having opposed first and second ends, the first end thereof being received by the opening formed through the lower closed end of said hollow pipe;
a first focusing lens mounted in said hollow pipe for focusing the solar radiation reflected by said secondary parabolic reflector on the first end of said fiber optic bundle;
a light distribution housing having an upper opening and a plurality of lower openings formed therethrough, the second end of said fiber optic bundle being received through the upper opening;
a plurality of optical fiber cables, each having opposed upper and lower ends, the upper ends thereof being respectively received by the plurality of lower openings formed through said light distribution housing;
a plano-convex lens positioned adjacent the upper opening of said light distribution housing for diverging the solar radiation transmitted through the fiber optic bundle;
a plurality of second focusing lenses mounted within said light distribution housing for focusing the solar radiation diverged by said plano-convex lens to respective ones of the upper ends of the plurality of optical fiber cables; and
a plurality of tertiary parabolic reflectors positioned adjacent respective ones of the lower ends of the plurality of optical fiber cables for reflecting the solar radiation onto a desired surface.

2. The solar illumination distribution system as recited in claim 1, further comprising a plurality of support rods, each having opposed first and second ends, the first end of each said support rod being secured to a circumferential edge of said primary parabolic reflector, the second end of each said support rod being secured to said secondary parabolic reflector.

3. The solar illumination distribution system as recited in claim 1, further comprising a removable ultraviolet filter for selectively and removably covering the upper open end of said hollow pipe.

4. The solar illumination distribution system as recited in claim 1, wherein said hollow pipe is telescopically adjustable.

5. The solar illumination distribution system as recited in claim 1, further comprising a solar tracking system for selectively positioning said primary parabolic reflector to track solar movement.

6. The solar illumination distribution system as recited in claim 1, wherein said fiber optic bundle comprises a plurality of optical fibers, wherein each said optical fiber comprises:
a silica glass core;
a zirconium fluoride glass cladding formed about the silica glass core;
a buffer layer formed about the zirconium fluoride glass cladding; and
a jacket formed about the buffer layer.

7. The solar illumination distribution system as recited in claim 1, further comprising a plurality of adjustable stands for respectively mounting said plurality of tertiary parabolic reflectors on the desired surface.

8. The solar illumination distribution system as recited in claim 1, further comprising a receptacle mounted on said secondary parabolic reflector for receiving a volume of water.

9. The solar illumination distribution system as recited in claim 1, wherein each said tertiary parabolic reflector comprises a plated aluminum mirror having a coating of silver nanoparticles.

10. The solar illumination distribution system as recited in claim 9, wherein the coating further comprises chromium nanoparticles.

11. The solar illumination distribution system as recited in claim 1, wherein each said tertiary parabolic reflector comprises a plated aluminum mirror having a coating of chromium nanoparticles.

12. A solar illumination distribution system, comprising:
a primary parabolic reflector having a central aperture formed therethrough;
a solar tracking system for selectively positioning said primary parabolic reflector to track solar movement;
a secondary parabolic reflector mounted adjacent a focal point of said primary parabolic reflector, whereby solar radiation is reflected from said primary parabolic reflector to said secondary parabolic reflector, said secondary parabolic reflector reflecting the solar radiation towards the central aperture formed through said primary parabolic reflector;
a hollow pipe having an upper open end and a lower closed end, the upper open end thereof being received by the central aperture formed through said primary parabolic reflector, the lower closed end having an opening formed therethrough;
a fiber optic bundle having opposed first and second ends, the first end thereof being received by the opening formed through the lower closed end of said hollow pipe;
a first focusing lens mounted in said hollow pipe for focusing the solar radiation reflected by said secondary parabolic reflector on the first end of said fiber optic bundle;
a light distribution housing having an upper opening and a plurality of lower openings formed therethrough, the second end of said fiber optic bundle being received through the upper opening;
a plurality of optical fiber cables, each having opposed upper and lower ends, the upper ends thereof being respectively received by the plurality of lower openings formed through said light distribution housing;
a plano-convex lens positioned adjacent the upper opening of said light distribution housing for diverging the solar radiation transmitted through the fiber optic bundle;
a plurality of second focusing lenses mounted within said light distribution housing for focusing the solar radiation diverged by said plano-convex lens to respective ones of the upper ends of the plurality of optical fiber cables; and
a plurality of tertiary parabolic reflectors positioned adjacent respective ones of the lower ends of the plurality of optical fiber cables for reflecting the solar radiation onto a desired surface.

13. The solar illumination distribution system as recited in claim 12, further comprising a plurality of support rods, each having opposed first and second ends, the first end of each said support rod being secured to a circumferential edge of said primary parabolic reflector, the second end of each said support rod being secured to said secondary parabolic reflector.

14. The solar illumination distribution system as recited in claim 12, further comprising a removable ultraviolet filter for selectively and removably covering the upper open end of said hollow pipe.

15. The solar illumination distribution system as recited in claim 12, wherein said hollow pipe is telescopically adjustable.

16. The solar illumination distribution system as recited in claim 12, wherein said fiber optic bundle comprises a plurality of optical fibers, wherein each said optical fiber comprises:
a silica glass core;
a zirconium fluoride glass cladding formed about the silica glass core;
a buffer layer formed about the zirconium fluoride glass cladding; and
a jacket formed about the buffer layer.

17. The solar illumination distribution system as recited in claim 12, further comprising a plurality of adjustable stands for respectively mounting said plurality of tertiary parabolic reflectors on the desired surface.

18. The solar illumination distribution system as recited in claim 12, further comprising a receptacle mounted on said secondary parabolic reflector for receiving a volume of water.

19. The solar illumination distribution system as recited in claim 12, wherein each said tertiary parabolic reflector comprises a plated aluminum mirror having a coating of metal nanoparticles.

20. The solar illumination distribution system as recited in claim 19, wherein the metal nanoparticles are selected from the group consisting of silver, chromium and a combination thereof.
